(19) United States
(12) Patent Application Publication
(10) Pub. No.: US 2012/0124527 A1
(43) Pub. Date: May 17, 2012

(54) PORTABLE ELECTRONIC DEVICE, AND CONTROL METHOD AND CONTROL PROGRAM FOR THE SAME

(75) Inventor: Ayako Fujii, Kanagawa (JP)

(73) Assignee: KYOCERA CORPORATION, Kyoto (JP)

(21) Appl. No.: 13/295,771

(22) Filed: Nov. 14, 2011

(30) Foreign Application Priority Data
Nov. 15, 2010 (JP) 2010-255148

(51) Int. Cl. G06F 3/033; G09G 5/00; G06F 3/041

(52) U.S. Cl. 715/863; 345/173; 345/650

(57) ABSTRACT

An object of the present invention is to provide a portable electronic device capable of performing character inputs of which usability is improved for users, and to provide a control method and a control program for the portable electronic device. Depending on a predetermined operation detected by a detecting unit, a character input control unit rotates a around area around a touched character “na”, and depending on rotation of the around area, the character input control unit cancels display of some characters of related characters based on a predetermined order, and displays new related characters related to the touched character “na” in the around area.

This application is based on and claims the benefit of priority from Japanese Patent Application No. 2010-255148 filed on 15 Nov. 2010, the content of which is incorporated herein by reference.

### BACKGROUND OF THE INVENTION

1. Field of the Invention

The present invention relates to a portable electronic device capable of detecting a touch on a display unit, and a control method and a control program for the portable electronic device.

2. Related Art

Conventionally, in a portable electronic device capable of detecting a touch on a display unit, in a state where virtual keys are displayed on the display unit, and hiragana characters with Japanese pronunciation involving a vowel “a” are assigned to the virtual keys, by touching one of the hiragana characters, virtual keys of hiragana characters involving the same consonant as the touched hiragana character are displayed around the virtual key of the touched hiragana character. In addition, an input of a desired hiragana character has been possible by performing a sliding operation to a point corresponding to a virtual key of any one of the hiragana characters thus displayed (for example, see Japanese Unexamined Patent Application, Publication No. 2009-266236).

### SUMMARY OF THE INVENTION

However, in a portable electronic device disclosed in Patent Document 1, in a state where virtual keys are displayed on a display unit, and hiragana characters with Japanese pronunciation involving a vowel “a” are assigned to the virtual keys, it has been possible to input only hiragana characters involving the same consonant as the hiragana characters thus displayed.

An object of the present invention is to provide a portable electronic device capable of performing character inputs of which usability is improved for users, and to provide a control method and a control program for the portable electronic device.

In order to solve the aforementioned problem, the portable electronic device according to the present invention includes: a display unit; a detecting unit that is correspondingly disposed in a screen of the display unit to detect a touch gesture; a storage unit that stores a plurality of characters; and a control unit that displays, on the screen, a plurality of input candidates for inputting a character, in which, in a case in which the detecting unit detects a touch gesture on the input candidate, the control unit displays related characters related to a touched input candidate, in a around area around the touched input candidate, depending on a touch gesture, the control unit rotates the related characters around the touched input candidate, and wherein, depending on a touch gesture, the control unit cancels display of some characters of the related characters, and displays new related characters related to the touched input candidate in the around area.

In order to solve the aforementioned problem, a method of controlling a portable electronic device according to the present invention includes the steps of: displaying, on a display unit, a plurality of input candidates for inputting a character; detecting, by way of a detecting unit, a touch gesture on the input candidate; in a case in which the detecting unit detects a touch on the input candidate, displaying related characters related to a touched input candidate in a around area around the touched input candidate; depending on a touch gesture detected by the detecting unit, rotating the around area around the touched input candidate; and depending on a touch gesture, canceling display of some characters of the related characters, and displaying new related characters related to the touched input candidate in the around area.

In order to solve the aforementioned problem, a program according to the present invention is a control program for operating a computer of a portable electronic device, and the control program includes the steps of: displaying, on a display unit, a plurality of input candidates for inputting a character; detecting, by way of a detecting unit, a touch gesture on the input candidate; in a case in which the detecting unit detects a touch on the input candidate, displaying related characters related to a touched input candidate in a around area around the touched input candidate; depending on a touch gesture detected by the detecting unit, rotating the around area around the touched input candidate; and depending on a touch gesture, canceling display of some characters of the related characters, and displaying new related characters related to the touched input candidate in the around area.

According to the present invention, it is possible to provide a portable electronic device capable of performing character inputs of which usability is improved for users, and to provide a control method and a control program for the portable electronic device.

### BRIEF DESCRIPTION OF THE DRAWINGS

FIG. 1 is a perspective view showing an appearance of a cellular telephone device according to the present embodiment;

FIG. 2 is a block diagram showing a functional configuration of the cellular telephone device;

FIG. 3 is a view showing an example (1) of transition of a screen displayed on the display unit according to the present embodiment;

FIG. 4 is a view showing a screen displayed on the display unit according to the present embodiment;

FIG. 5 is a view showing an example (2) of transition of a screen displayed on the display unit according to the present embodiment;

FIG. 6 is a view showing an example (3) of transition of a screen displayed on the display unit according to the present embodiment; and

FIG. 7 is a flowchart showing internal processing of examples illustrated in FIGS. 3 to 6.

### DETAILED DESCRIPTION OF THE INVENTION

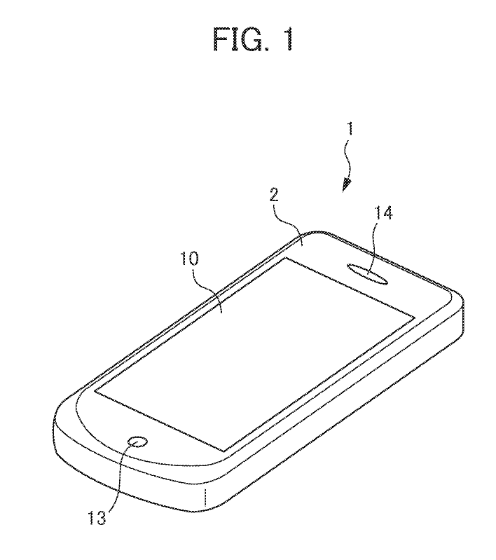

Descriptions are provided hereinafter regarding an embodiment of the present invention. First of all, with reference to FIG. 1, descriptions are provided for a basic structure of a cellular telephone device 1 according to an embodiment of the portable electronic device of the present invention. FIG. 1 is a perspective view showing an appearance of the cellular telephone device 1 according to the present embodiment.

The cellular telephone device 1 includes a body 2. A touch panel 10, a microphone 13 and a speaker 14 are disposed on a front face portion of the body 2.

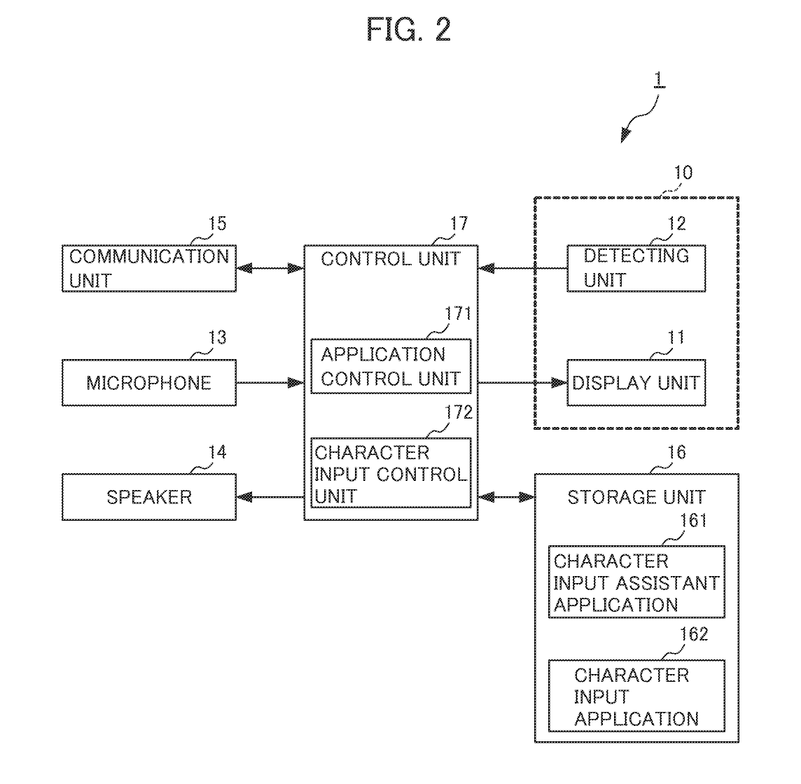

The touch panel 10 includes a display unit 11 and a detecting unit 12 (see FIG. 2). The display unit 11 is a liquid-crystal display panel, an organic EL (electroluminescence) display panel, or the like. The detecting unit 12 is a sensor that detects a touch by an object, such as a finger or stylus of a user of the cellular telephone device 1, on the display unit 11. The detecting unit 12 is correspondingly disposed in the surface of display unit 11, and for example, a sensor that employs a capacitive sensing method or a resistive film method can be utilized as the detecting unit 12.

The microphone 13 is used for inputting sound produced by the user of the cellular telephone device 1 during a telephone call. The speaker 14 is used for outputting sound produced by the other party whom the user of the cellular telephone device 1 is talking with during a phone call.

Next, a functional configuration of the cellular telephone device 1 is described with reference to FIG. 2. FIG. 2 is a block diagram showing a functional configuration of the cellular telephone device 1.

The cellular telephone device 1 includes the touch panel (the display unit 11 and the detecting unit 12), the microphone 13, and the speaker 14, as described above. In addition, the cellular telephone device 1 includes a communication unit 15, a storage unit 16, and a control unit 17.

The communication unit 15 includes a main antenna and an RF circuit unit, and makes an outgoing call to and performs communication with a predetermined contact entity. The contact entity, to which the communication unit 15 makes an outgoing call, is an emergency contact entity such as, for example, the police or fire station. Moreover, the contact entity, to which the communication unit 15 makes an outgoing call, is an external device that performs a telephone call or mail transmission/reception with the cellular telephone device 1, or an external device or the like such as an external web server, with which the cellular telephone device 1 establishes Internet connections.

The communication unit 15 performs communication with an external device via a predetermined usable frequency band. More specifically, the communication unit 15 executes demodulation processing of a signal received via the main antenna, and transmits the processed signal to the control unit 17. In addition, the communication unit 15 executes modulation processing of a signal transmitted from the control unit 17, and transmits the signal to an external device (base station) via the main antenna.

The storage unit 16 includes, for example, working memory, and is utilized for arithmetic processing by the control unit 17. Furthermore, the storage unit 16 stores a single or plurality of applications or databases that are operated inside the cellular telephone device 1. It should be noted that the storage unit 16 may also serve as detachable external memory.

The control unit 17 controls the entirety of the cellular telephone device 1, and performs control of the display unit 11 and the communication unit 15.

The storage unit 16 and the control unit 17 of the present embodiment may be configured with a general computer. Such a general computer includes, for example, a central processing unit (CPU) as the control unit 17, and memory (RAM, ROM) and a hard disk (HDD) as the storage unit 16. In such a general computer, the control unit 17 controls the cellular telephone device 1 in an integrated manner, and appropriately reads various programs from the storage unit 16 to execute the programs, thereby implementing various functions according to the present invention, in collaboration with the display unit 11, the detecting unit 12, the microphone 13, the speaker 14 and the communication unit 15 that are described above.

The cellular telephone device 1 according to the present embodiment has a function to input characters of different character types. A configuration for executing the functions is hereinafter described.

As shown in FIG. 2, the storage unit 16 includes a character input assistant application 161 and a character input application 162; and the control unit 17 includes an application control unit 171 and a character input control unit 172.

The character input assistant application 161 is a so-called IME (Input Method Editor) that is an application program to assist character inputs in the cellular telephone device 1. For example, the character input assistant application 161 has a function to convert characters that are input, and a function to display conversion candidates and input candidates on the display unit 11. Moreover, the character input assistant application 161 stores characters corresponding to a plurality of character types (for example, hiragana characters, katakana characters, alphabetic characters, numeric characters, symbols, pictograms, pictograms for decorated mail, etc.).

Here, the characters according to the present embodiment include not only hiragana characters, katakana characters and kanji character, but also numeric characters, alphabetic characters, symbols, pictograms, and pictograms for decorated mail. In addition, a character includes not only a single character but also a character string.

For example, in response to a touch or the like on the detecting unit 12, the application control unit 171 activates and terminates the character input application 162 (such as, for example, a memo pad application, an electronic mail application, a document creation application, etc.), and activates and terminates the character input assistant application 161.

In the character input application 162 activated by the application control unit 171, by using the character input assistant application 161, the character input control unit 172 displays a plurality of input candidates for inputting a character of any one of the plurality of character types, on the display unit 11.

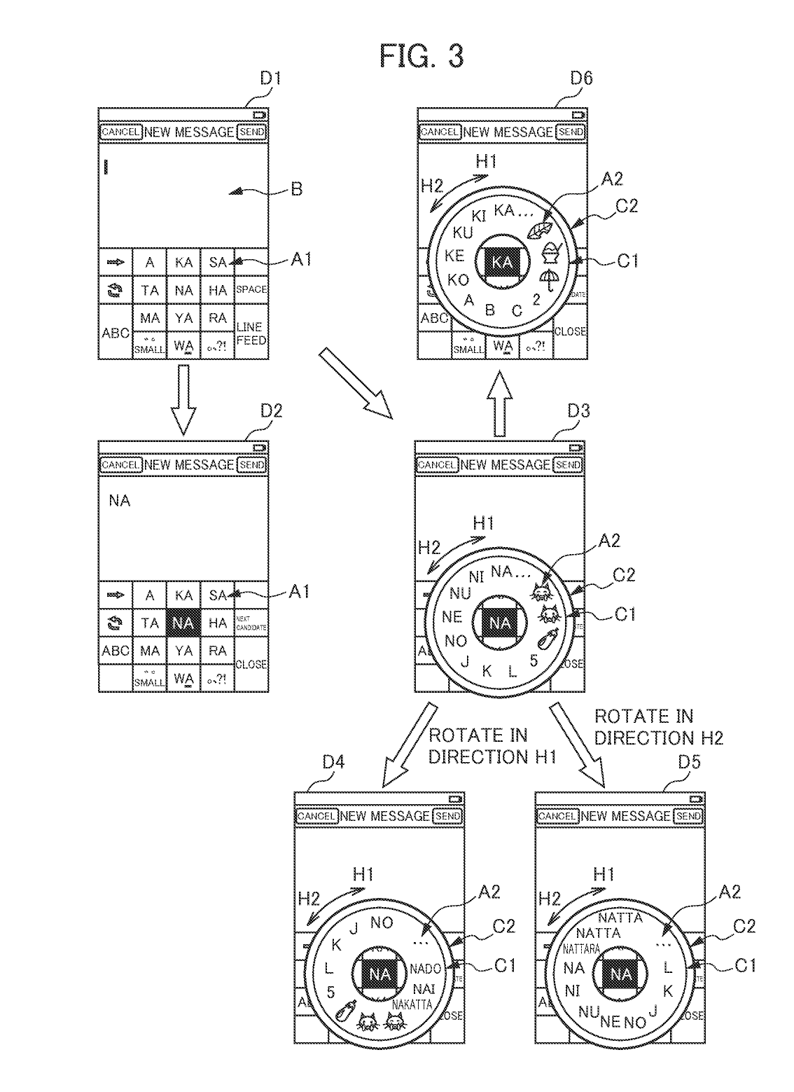

FIG. 3 is a view showing an example of transition of a screen displayed on the display unit 11 according to the present embodiment. In a screen D1 in the FIG. 3, the character input assistant application 161 and the character input application 162 are activated. Furthermore, in the screen D1 in FIG. 3, the character input assistant application 161 displays first input candidates A1 as software keys, and the character input application 162 displays a character input area B.

In addition, in the screen D1, input candidates displayed as the first input candidates A1 are hiragana characters: “a”, “ka”, “sa”, “ta”, “na”, “ha”, “ma”, “ya”, “ra”, “voiced consonant, semivoiced consonant, small character (for converting input characters into characters of voiced consonant, semivoiced consonant and small character, respectively)”, “wa”, and symbols “. , ? !”. Furthermore, a key “ABC” is a software key for switching the input mode from a hiragana input mode to an alphanumeric input mode.

In the screen D1, when the detecting unit 12 detects a touch on a point corresponding to an input candidate “na” as the first input candidate A1 on the display unit 11, the character input control unit 172 selects the input candidate “na”, and when the detected touch is released, the character input control unit 172 displays the hiragana character “na” in the character input area B (a screen D2).

Moreover, in the screen D1, in a case in which the detecting unit 12 detects a touch on the hiragana character “na”, which is displayed as the first input candidate A1 on the display unit 11, and the touch continues for more than a predetermined period of time, then the character input control unit 172 displays related characters related to the hiragana character “na” thus touched (hereinafter referred to as the touched character “na”) in a around area C1 around the touched character “na” on the display unit 11 (a screen D3).

More specifically, in a case in which the touch on the touched character “na” detected by the detecting unit 12 continues for more than a first period of time T1, the character input control unit 172 displays second input candidates A2 in the around area C1 on the display unit 11 (the screen D3), in which the second input candidates A2 include conversion candidates of the touched character “na”, characters of the same character type having a first relationship with the touched character “na”, or characters of different character types having a second relationship with the touched character “na”.

Here, the second input candidates A2 as the conversion candidates of the touched character “na” are conversion candidates of which initial character is the touched character “na”, and include hiragana character strings such as “nakatta”, “nai” and “nado” (see a screen D4). In addition, the second input candidates A2 as the characters of the same character type having the first relationship with the touched character “na” are hiragana characters of which consonant is the same as the consonant of the touched character “na”, such as “ni”, “nu”, “ne” and “no” (see the screen D3).

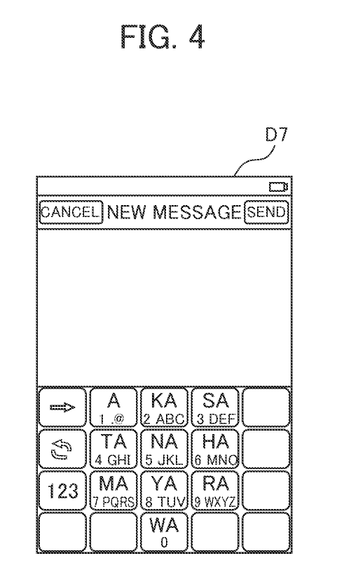

Furthermore, in a case in which characters of a plurality of character types are assigned to a single key, the second input candidates A2 as the characters of the different character types having the second relationship with the touched character “na” include other characters assigned to the same key for the touched character “na”. More specifically, as shown in a screen D7 in FIG. 4, in a case in which virtual keys each corresponding to a plurality of character types are displayed on the display unit 11, and a hiragana character, a numeric character, an alphabetic character and a symbol are assigned to each single key, characters assigned to the touched character “na” include a numeric character “5” and alphabetic characters “J, K, L” of character types different from the character type of the touched character “na”.

FIG. 4 is a view showing a screen displayed on the display unit 21 according to the present embodiment. As shown in FIG. 4, in place of the screen D1 in FIG. 3, the character input control unit 172 may display virtual keys each corresponding to a plurality of character types on the display unit 21. For example, the display mode of the screen D7 is the hiragana input mode, and the alphabetic characters “J, K, L” are assigned to the key of the hiragana character “na”; however, the user can input characters of different character types by switching to a different character mode by way of another key.

Furthermore, the second input candidates A2 may include an image(s) of which initial character in its name is the touched character “na”. More specifically, as shown in the screen D3 in FIG. 3, the second input candidates A2 may be pictograms of “nakiwarai (crying and laughing)”, “namida (tears)” and “nasu (eggplant)” of which initial character is the touched character “na”. Moreover, the second input candidates A2 may include not only pictograms but also pictograms for decorated mail, and may also include emoticons (for example, “(/_-.)” (crying)).

In the screen D3, the character input control unit 172 displays a touch area C2 for rotating the around area C1 around the touched character “na”, outside the around area C1 on the display unit 11.

Furthermore, in the screen D3, depending on a predetermined operation detected by the detecting unit 12, the character input control unit 172 rotates the around area C1 around the touched character “na”, and depending on the rotation of the around area C1, the character input control unit 172 cancels the display of some characters of the related characters based on a predetermined order, and displays new related characters related to the touched character “na” in the around area C1.

More specifically, in the screen D3, when the detecting unit 12 detects an operation to slide the touch area C2 in a direction H1, the character input control unit 172 rotates the around area C1 clockwise. In addition, depending on the rotation of the around area C1, the character input control unit 172 cancels the display of some characters of the related characters (the related characters “na”, “ni”, “nu”, “ne” and “no”) based on a predetermined order, and displays new related characters (related character strings such as “nakatta”, “nai” and “nado”) related to the touched character “na”, in the around area C1 (the screen D4).

On the other hand, in the screen D3, when the detecting unit 12 detects an operation to slide the touch area C2 in a direction H2, the character input control unit 172 rotates the around area C1 anticlockwise. In addition, depending on the rotation of the around area C1, the character input control unit 172 cancels the display of some characters of the related characters (pictograms “nakiwarai (crying and laughing”), “namida (tears)” and “nasu (eggplant)” as the related characters, and a numeric character “5”) based on a predetermined order, and displays new related characters (related character strings “natta (sounded)”, “natta (became)”, and “nattara (then (the meaning of “nattara” in the Japanese language varies depending on the context))”) related to the touched character “na”, in the around area C1 (the screen D5).

It should be noted that, regarding related character strings having a large number of characters among the related characters related to the touched character “na”, the character input control unit 172 may display such related character strings by reducing the number of characters (for example, restricting to three characters from the head of the character string) in the around area C1. Furthermore, regarding characters (or character strings) that are considered to be synonyms in the related characters related to the touched character “na”, the character input control unit 172 displays a representative character (or character string) that represents such related characters. In addition, when a representative character is selected, the character input control unit 172 may display synonyms of the representative character in the vicinity of the representative character. Examples of a representative character string and its synonyms may include a representative character string “ohayoh (good morning)” and its synonyms “ohayougozaimasu”, “ohayo”, “oha”, etc.

Here, the predetermined order may be, for example, from a character of the same character type having the first relationship with the touched character “na”, to a character of a different character type having the second relationship with the touched character “na”, to a pictogram representing an image of which initial character in its name is the touched character “na”, to a conversion candidate of which initial character is the touched character “na”; alternatively, the predetermined order may be an arbitrary order that has been set by the user.

Moreover, in a state where the around area C1 is displayed around the touched character “na” on the display unit 11 (the screen D3), in a case in which the detecting unit 12 detects a touch on an other character (for example, a hiragana character “ka”), which is different from the touched character “na”, among characters of any character type displayed as input candidates on the display unit 11, the character input control unit 172 displays characters related to the other character in another around area C1 around the other character (see the screen D6).

More specifically, in the screen D6, the character input control unit 172 displays: characters (hiragana characters “ki”, “ku”, “ke” and “ko”) of the same character type having the first relationship with the other character “ka” that is different from the touched character “na”; characters (a numeric character “2” and alphabetic characters “A, B, C”) of different character types having the second relationship with the other character “ka”; and pictograms having names of which initial character is the other character “ka”, such as “kasa (umbrella)”, “kakigohri (shaved ice)”, “kareha (dead leaf)”, etc., in the around area C1 around the other character “ka” (see the screen D6).

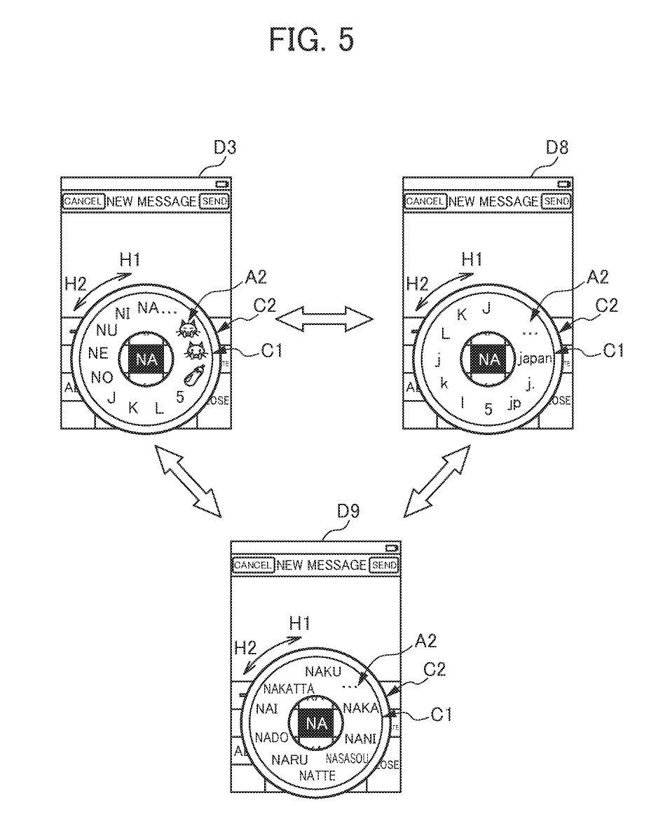

In addition, in a case in which the detecting unit 12 detects an operation (for example, an operation to slide an area outside the touch area C2 in the direction H1 or H2) that is different from the predetermined operation, depending on the rotation of the around area C1, the character input control unit 172 may switch to display, conversion candidates of which initial character is the touched character “na”, characters of the same character type having the first relationship with the touched character “na”, and characters of different character types having the second relationship with the touched character “na”, in the around area C1 (see FIG. 5).

In addition, as shown in FIG. 4, in a case in which the touch on the touched characters “GHI” detected by the detecting unit 12 continues for more than a first period of time T1, the character input control unit 172 may display second input candidates A2 in the around area C1 on the display unit 11, in which the second input candidates A2 include conversion candidates of the touched characters “GHI”, characters of the same character type having a first relationship with the touched characters “GHI”, or characters of different character types having a second relationship with the touched characters “GHI”.

Here, the second input candidates A2 as the conversion candidates of the touched characters “GHI” include alphabetic character such as “g”, “h”, “i”, “G”, “H” and “I”. In addition, the second input candidates A2 as the characters of the same character type having the first relationship with the touched characters “GHI” include alphabetic character such as “home”, “horse” and “hall”.

Furthermore, in a case in which characters of a plurality of character types are assigned to a single key, the second input candidates A2 as the characters of the different character types having the second relationship with the touched characters “GHI” include other characters assigned to the same key for the touched characters “GHI”. More specifically, as shown in a screen D7 in FIG. 4, in a case in which virtual keys each corresponding to a plurality of character types are displayed on the display unit 11, and a hiragana character, a numeric character, an alphabetic character and a symbol are assigned to each single key, characters assigned to the touched character “GHI” include a numeric character “4” and hiragana characters “ta, ti, tu, te, to” of character types different from the character type of the touched characters “GHI”.

FIG. 5 is a view showing an example of transition of a screen displayed on the display unit 11 according to the present embodiment. For example, as shown in FIG. 5, in a case in which the detecting unit 12 detects an operation to slide the area outside the touch area C2 in the direction H1, depending on the rotation of the around area C1, the character input control unit 172 may switch to display, from characters of the same character type having the first relationship with the touched character “na” to characters of different character types having the second relationship with the touched character “na”, in the around area C1 (the screens D3 and D8).

Furthermore, in a case in which the detecting unit 12 detects an operation to slide the area outside the touch area C2 in the direction H2, depending on the rotation of the around area C1, the character input control unit 172 may switch to display, from characters of the same character type having the first relationship with the touched character “na” to conversion candidates of which initial character is the touched character “na”, in the around area C1 (the screens D3 and D9).

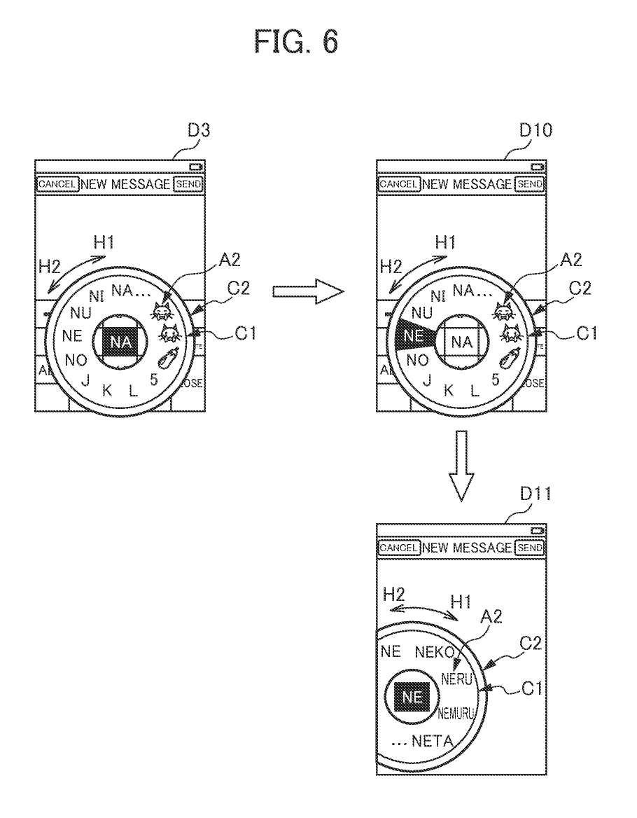

FIG. 6 is a view showing an example of transition of a screen displayed on the display unit 11 according to the present embodiment. As shown in FIG. 6, in the screen D3, in a state where the around area C1 is displayed around the touched character “na” on the display unit 11 (the screen D3), in a case in which the detecting unit 12 detects a touch on a related character “ne” related to the touched character “na” (a screen D10), the character input control unit 172 displays characters related to the related character “ne” (for example, conversion candidates “ne (that is a single katakana character)”, “neko (cat)”, “neru (sleep)”, “neta (slept)”) in the around area around the related character “ne” (a screen D11).

In the screen D11, in a case in which the around area C1 cannot be entirely displayed on the display unit 11, the character input control unit 172 may display a part of the around area C1. In this case, depending on a predetermined operation detected by the detecting unit 12, the character input control unit 172 rotates the around area C1 around the related character “ne”, and depending on the rotation of the around area C1, the character input control unit 172 cancels the display of some characters of the related character “ne” based on a predetermined order, and displays, in the around area C1, related characters being related to the related character “ne” and being not displayed in the around area C1.

In this way, according to the cellular telephone device 1 of the present embodiment, depending on a predetermined operation detected by the detecting unit 12, the character input control unit 172 rotates the around area C1 around the touched character, and depending on the rotation of the around area C1, the character input control unit 172 cancels the display of some characters of the related characters based on a predetermined order, and displays new related characters related to the touched character in the around area C1. As a result, since the cellular telephone device 1 displays characters other than the touched character on the display unit 11, the user can easily input desired characters by selecting characters other than the touched character.

Moreover, in a case in which the touch on the touched character detected by the detecting unit 12 continues for more than the first period of time T1, the character input control unit 172 displays the second input candidates A2 in the around area C1 on the display unit 11, in which the second input candidates A2 include conversion candidates of the touched character, characters of the same character type having the first relationship with the touched character, or characters of different character types having the second relationship with the touched character. As a result, in the cellular telephone device 1, conversion candidates for the touched character, characters of the same character type as the touched character, and characters of character types different from the touched character can be easily input.

In addition, in a case in which the detecting unit 12 detects an operation different from a predetermined operation, depending on the rotation of the around area C1, the character input control unit 172 switches to display, conversion candidates of which initial character is the touched character, characters of the same character type having the first relationship with the touched character, and characters of different character types having the second relationship with the touched character, in the around area C1. As a result, in the cellular telephone device 1, conversion candidates for the touched character, characters of the same character type as the touched character, and characters of character types different from the touched character can be more easily switched.

Furthermore, the character input control unit 172 displays the touch area C2 for rotating the around area C1 around the touched character, outside the around area C1 on the display unit 11. As a result, in the cellular telephone device 1, related characters related to the touched character can be easily selected by way of a sliding operation of the touch area C2.

Moreover, in a state where the around area C1 is displayed around the touched character on the display unit 11, in a case in which the detecting unit 12 detects a touch on an other character, which is different from the touched character, among characters of any character type displayed as input candidates on the display unit 11, the character input control unit 172 displays characters related to the other character in another around area C1 around the other character. As a result, in the cellular telephone device 1, other characters different from the touched character can be easily input.

In addition, in a state where the around area C1 is displayed around the touched character on the display unit 11, in a case in which the detecting unit 12 detects a touch on a related character related to the touched character, the character input control unit 172 displays characters related to the related character in the around area around the related character. As a result, in the cellular telephone device 1, characters related to the related characters can be easily input.

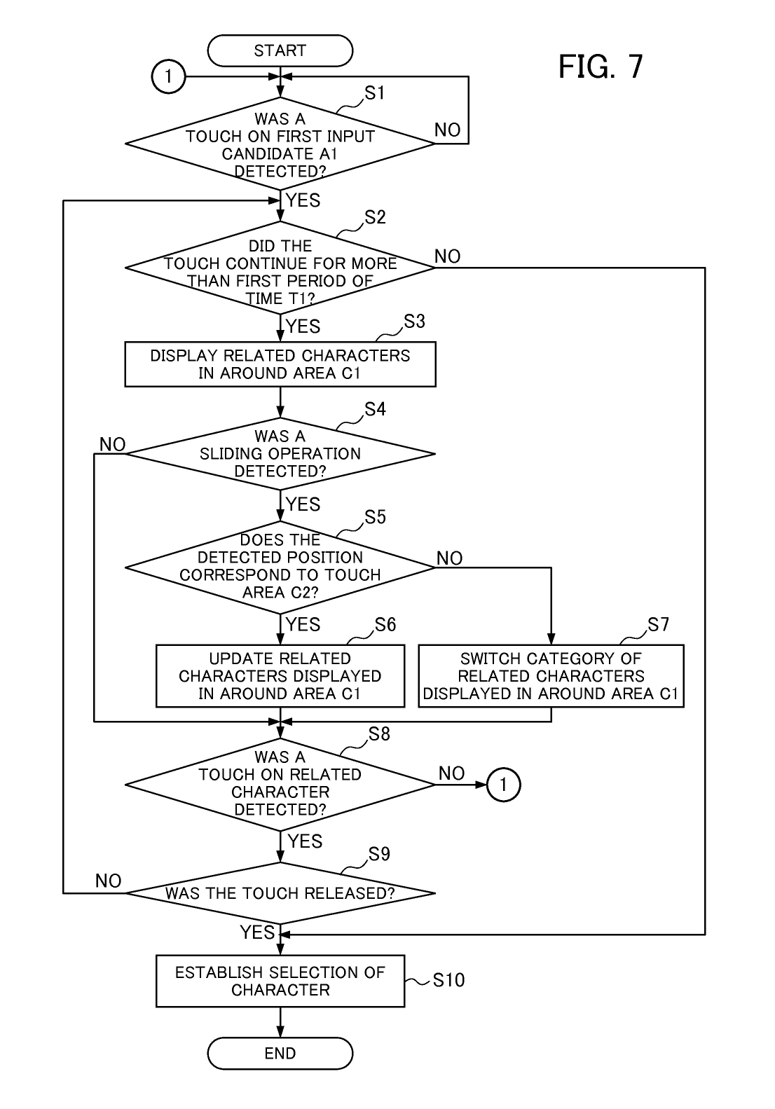

FIG. 7 is a flowchart showing internal processing of the examples illustrated in FIGS. 3 to 6. In Step S1, the character input control unit 172 determines whether the detecting unit 12 has detected a touch on a point corresponding to any one of the first input candidates A1 on the display unit 11. In a case in which the detecting unit 12 has detected a touch on a point corresponding to any one of the first input candidates A1 (YES), the processing advances to Step S2. In a case in which the detecting unit 12 has not detected a touch on a point corresponding to any one of the first input candidates A1 (NO), the processing of Step S1 is repeated.

In Step S2, the character input control unit 172 determines whether the touch on the first input candidate A1 has continued for more than the first period of time T1. In a case in which the touch has continued for more than the first period of time T1 (YES), the processing advances to Step S3. In a case in which the touch has not continued for more than the first period of time T1, i.e. the touch was released within the first period of time T1 (NO), the processing advances to Step S9.

In Step S3, the character input control unit 172 displays related characters related to the touched character, which has been thus touched, in the around area C1 around the touched character on the display unit 11.

In Step S4, the character input control unit 172 determines whether the detecting unit 12 has detected a sliding operation in a predetermined direction from a position corresponding to the touched character on the display unit 11. In a case in which a sliding operating has been detected (YES), the processing advances to Step S5. In a case in which a sliding operating has not been detected (NO), the processing advances to Step S8.

In Step S5, the character input control unit 172 determines whether a position of the sliding operation detected by the detecting unit 12 is a position corresponding to the touch area C2. In a case in which the position is a position corresponding to the touch area C2 (YES), the processing advances to Step S6. In a case in which the position is not a position corresponding to the touch area C2 (NO), the processing advances to Step S7.

In Step S6, depending on the sliding operation, the character input control unit 172 rotates the around area C1 around the touched character, and depending on the rotation of the around area C1, the character input control unit 172 cancels the display of some characters of the related characters based on a predetermined order, and displays new related characters related to the touched character in the around area C1. In other words, depending on the sliding operation, the character input control unit 172 sequentially updates related characters displayed in the around area C1.

In Step S7, depending on the sliding operation, the character input control unit 172 rotates the around area C1 around the touched character, and depending on the rotation of the around area C1, the character input control unit 172 switches to display, conversion candidates of which initial character is the touched character, characters of the same character type having the first relationship with the touched character, and characters of different character types having the second relationship with the touched character, in the around area C1. In other words, the character input control unit 172 switches the category of the related characters depending on the sliding operation.

In Step S8, the character input control unit 172 determines whether the detecting unit 12 has detected a touch on a related character displayed in the around area C1. In a case in which a touch on a related character has been detected (YES), the processing advances to Step S9. In a case in which a touch on a related character has not been detected (NO), the processing returns to Step S1.

In Step S9, the character input control unit 172 determines whether the touch detected by the detecting unit 12 on the display unit 11 has been released. In a case in which the touch has been released (YES), the processing advances to Step S10. In a case in which the touch has not been released (NO), the processing returns to Step S2.

In Step S10, the character input control unit 172 determines selection of a character, and terminates the processing. In this way, according to the cellular telephone device 1 of the present embodiment, the user can easily input characters of different character types by selecting characters other than the touched character.

Although the embodiment of the present invention has been described above, the present invention is not limited to the aforementioned embodiment, and can be altered as appropriate. Moreover, although the cellular telephone device 1 as a portable electronic device has been described in the aforementioned embodiment, the cellular telephone device 1 can be applied to other electronic devices. For example, the portable electronic device of the present invention may be a digital camera, a PHS (Personal Handyphone System), a PDA (Personal Digital Assistant), a portable navigation device, a personal computer, a notebook PC, a mobile gaming device or the like.

What is claimed is:

1. A portable electronic device, comprising:
a display unit;
a detecting unit that is correspondingly disposed in a screen of the display unit to detect a touch gesture;
a storage unit that stores a plurality of characters; and
a control unit that displays, on the screen, a plurality of input candidates for inputting a character,
wherein, in a case in which the detecting unit detects a touch gesture on the input candidate, the control unit displays related characters related to a touched input candidate, in a around area around the touched input candidate,
wherein, depending on a touch gesture, the control unit rotates the related characters around the touched input candidate, and wherein, depending on a touch gesture, the control unit cancels display of some characters of the related characters, and displays new related characters related to the touched input candidate in the around area.

2. The portable electronic device according to claim 1, wherein the related characters include conversion candidates of the touched input candidate.

3. The portable electronic device according to claim 2,
wherein the related characters include: characters of a same character type having a first relationship with the touched input candidate; and/or characters of different character types having a second relationship with the touched input candidate.

4. The portable electronic device according to claim 3,
wherein the related characters include: conversion candidates of the touched input candidate; characters of a same character type having a first relationship with the touched input candidate; and characters of different character types having a second relationship with the touched input candidate, and wherein, in a case in which the detecting unit detects a touch gesture different from a touch gesture for rotating the related characters, depending on the rotation of the radial area, the control unit changes to display, the conversion candidates, the characters of the same character type, and the characters of the different character types as the related characters in the around area.

5. The portable electronic device according to claim 1, wherein the control unit displays a touch area for rotating the around area around the touched input candidate.

6. The portable electronic device according to claim 1,
wherein, in a state where the around area is displayed around the touched input candidate, in a case in which the detecting unit detects a touch gesture on an other input candidate different from the touched input candidate, the control unit displays another related characters related to the other input candidate in a around area around the other input candidate.

7. The portable electronic device according to claim 1, wherein, in a case in which the detecting unit detects a touch gesture on the related character, the control unit displays characters related to the touched related character in a around area around the touched related character.

8. A method of controlling a portable electronic device, the method comprising the steps of:
displaying, on a display unit, a plurality of input candidates for inputting a character;
detecting, by way of a detecting unit, a touch gesture on the input candidate;
in a case in which the detecting unit detects a touch on the input candidate, displaying related characters related to a touched input candidate in a around area around the touched input candidate;
depending on a touch gesture detected by the detecting unit, rotating the around area around the touched input candidate; and depending on a touch gesture, canceling display of some characters of the related characters, and displaying new related characters related to the touched input candidate in the around area.

9. A control program for operating a computer of a portable electronic device, the control program comprising the steps of:
displaying, on a display unit, a plurality of input candidates for inputting a character;
detecting, by way of a detecting unit, a touch gesture on the input candidate;
in a case in which the detecting unit detects a touch on the input candidate, displaying related characters related to a touched input candidate in a around area around the touched input candidate;
depending on a touch gesture detected by the detecting unit, rotating the around area around the touched input candidate; and depending on a touch gesture, canceling display of some characters of the related characters, and displaying new related characters related to the touched input candidate in the around area.
